(19) United States
(12) Patent Application Publication
(10) Pub. No.: US 2007/0001335 A1
(43) Pub. Date: Jan. 4, 2007

(54) Method for manufacturing anti-bacteria silicone rubber compound

(75) Inventors: Chia-Hsu Lin, Tianwei Township (TW); His-Tsung Hung, Hukou Township (TW); Po-Cheng Hung, Hukou Township (TW); Kao Pan Hsin Fu, Hukou Township (TW)

Correspondence Address: TROXELL LAW OFFICE PLLC, SUITE 1404, 5205 LEESBURG PIKE, FALLS CHURCH, VA, 22041, US

(73) Assignees: Linco Baby Merchandise Work's Co., Ltd.; Shin-Etsu Silicone Taiwan Co., Ltd.

(21) Appl. No.: 11/171,408

(22) Filed: Jul. 1, 2005

(51) Int. Cl. B29C 45/00

(52) U.S. Cl. 264/102; 264/328.2; 264/328.17; 264/328.18

(57) ABSTRACT

A method for manufacturing anti-bacteria silicone rubber compound includes a first step of preparing anti-bacteria basic material by mixing an anti-bacteria agent and silicon oil in a proper proportion and temperature, a second step of rolling and pressing for several times for dispersing the anti-bacteria basic material, a third step of adding the dispersed anti-bacteria basic material in transparent two-liquid-type A/B basic material and stirring this mixture for several times for dispersing it into anti-bacteria silicone rubber compound liquid as a semi-product, and a fourth step of pouring the semi-product in an injecting molding machine for molding various finished semi-transparent anti-bacteria silicone rubber compound products.

### BACKGROUND OF THE INVENTION

1. Field of the Invention

This invention relates to silicone rubber compound, particularly to a method for manufacturing silicone rubber compound with anti-bacteria function and having a balanced pristine semi-transparent property.

2. Description of the Prior Art

There is wide variety of anti-bacteria silicone rubber compound products such as nipples, nose suckers, baby hygienic articles, etc. Generally speaking, makers firstly prepare anti-bacteria silicone rubber compound and then pour it in molds for injection molding and hardened as finished products. But, most of products made of the anti-bacterial silicone rubber compound are not transparent, attached with very tiny grains irregularly on its inner surface.

A conventional method for manufacturing products with anti-bacteria silicone rubber compound is not so ideal, resulting in products often formed with undesirable tiny grains on an outer or inner surface by an anti-bacteria agent after hardened. So their outer appearance may be impaired to have inferior looking for selling, and the tiny grains may be mistaken as dirty spots for users difficult to discern, so they make up confusion in cleaning.

### SUMMARY OF THE INVENTION

This invention offers a method for manufacturing anti-bacteria silicone rubber compound, in which an anti-bacteria basic material is made by mixing a anti-bacteria agent with silicone oil in a proper proportion and temperature, and then the anti-bacteria basic material is rolled and pressed several times for dispersion to get dispersed anti-bacteria basic material. Then the dispersed anti-bacteria basic material is added in a transparent two-component-liquid-type A/B basic material with proper viscosity and then this mixture is stirred several times for dispersion to get anti-bacteria silicone rubber compound as a semi-product, which is then filtered and poured in an injecting molding machine for making various finished anti-bacteria silicone rubber compound products. Thus finished anti-bacteria silicone rubber compound products not only have a good bacterial resisting effect, but also have a balance pristine semi-trans parent property, improving the flow of conventional silicone rubber compound products often attached with undesirable miscellaneous tiny grains.

### BRIEF DESCRIPTION OF A DRAWING

This invention will be better understood by referring to the accompanying drawing, wherein:

FIG. 1 is a block diagram of a method for manufacturing anti-bacteria silicone rubber compound in the present invention.

### DETAILED DESCRIPTION OF THE PREFERRED EMBODIMENT

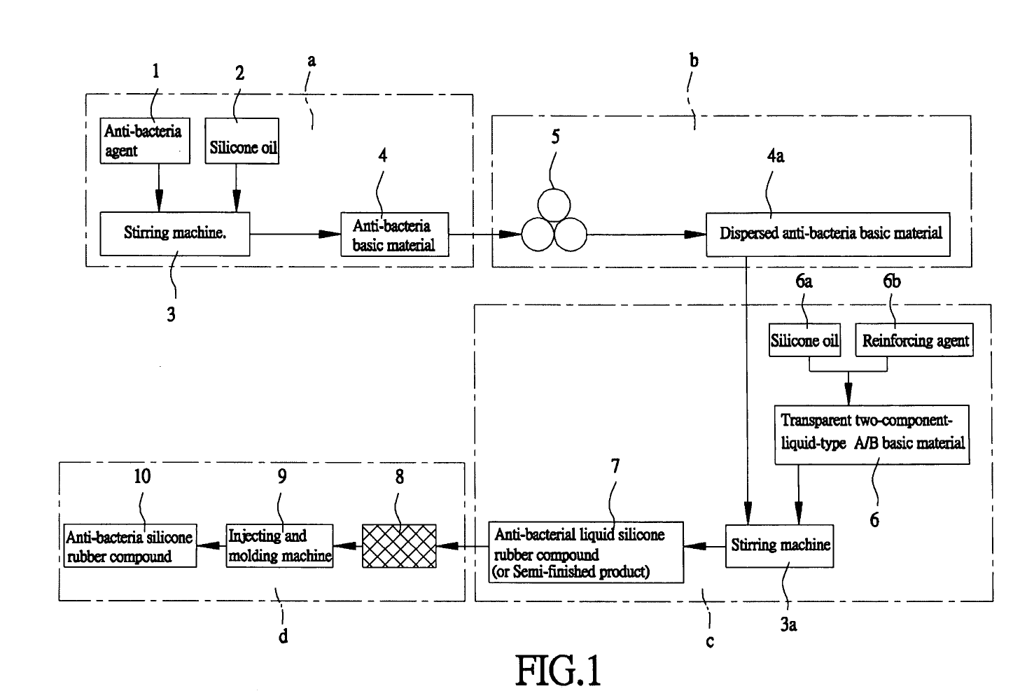

A method for manufacturing anti-bacteria silicone rubber compound in the present invention, as shown in FIG. 1, includes four steps described as follows.

(a) A first step: Making anti-bacteria basic material.

First prepare anti-bacteria agent 1 and silicone oil having viscosity 100 CS-500,000 CS, and then mix these two ingredients in the proportion 10:90-60:40. After that, the mixture is stirred in a universal stirring machine or a planetary stirring machine 3 for a first stage of low speed 0-5 rpm for 5-30 minutes, and for a second stage of high speed 15-60 rpm for 20-60 minutes, with these two stages control led in the temperature 20-60° C. Then the mixture becomes anti-bacteria basic material 4.

(b) A second step: Dispersing again the anti-bacteria basic material.

The anti-bacteria basic material 4 is rolled and pressed by three rollers 5 for dispersing 1-20 times, with the three rollers 5 kept in the temperature 15-50° C. getting dispersed anti-bacteria basic material 4a.

(c) A third step: Making the dispersed anti-bacteria basic material 4a into an anti-bacteria silicone rubber compound as a semi-finished product.

The dispersed anti-bacteria basic material 4a is added with 0.05-5 phr solely or evenly into a transparent two-component-liquid-type A/B basic material, which is a mixture of silicone oil 6 and a reinforcing agent 6b. After that, this mixture is poured in a planetary stirring machine 3a for stirring and dispersing for 1-5 times, with every stirring and dispersing action involving a first stage of low speed 10-50 rpm, a second stage of high speed 20-100 rpm, and a third stage of bubble removing by means of vacuuming with 1 Torr-100 Torr, and a fourth stage of low speed with bubble removing by means of vacuuming of 1 Torr-100 Torr, and a last fifth stage of high speed stirring and bubble removing by means of vacuuming with 1 Torr-100 Torr, with the temperature used in all the stages controlled in the scope of 15-70° C. Then the mixture becomes an anti-bacteria silicone rubber compound as a semi-finished product.

A fourth step: Manufacture anti-bacteria silicone rubber compound product wholly completed.

The anti-bacteria silicone rubber compound 7 (or the semi-finished product) is filtered by a metal or nylon net with the meshes 50-300, and then poured in an injecting molding machine 9 for molding various anti-bacteria semi-transparent silicone rubber compound products 10.

It is important to mention that the method in the invention cannot only makes anti-bacteria silicon products having bacteria resisting function, but also having balanced pristine semi-transparency without any undesirable tiny grains on an inner or an outer surface so that a user can easily discern dirty spots for cleaning to keep the products clean and neat.

While the preferred embodiment of the invention has been described above, it will be recognized and understood that various modifications may be made therein and the appended claims are intended to cover all such modifications that may fall within the spirit and scope of the invention.

What is claimed is:

1. A method for manufacturing anti-bacteria silicone rubber compound, said method comprising:
(a) A first step of preparing an anti-bacteria agent and silicon oil, and of mixing the two ingredients in a proper proportion and a proper temperature to get an anti-bacteria basic material:
(b) A second step of rolling and pressing for dispersing for several times the anti-bacteria basic material finishing the first step to get a dispersed anti-bacteria basic material:
(c) A third step of adding the dispersed anti -bacteria basic material finishing the second step in a transparent two-component-liquid-type A/B basic material and then stirring and dispersing this mixture for several times to get an anti-bacteria silicone rubber compound liquid as a semi-finished product: and,
(d) A fourth step of pouring the anti-bacteria liquid silicone rubber compound finishing the third step in an injecting molding machine for molding various finished anti-bacteria semi-transparent silicone rubber compound products.

2. The method for manufacturing anti-bacteria silicone rubber compound as claimed in claim 1, wherein said anti-bacteria agent and said silicone oil are mixed in the proportion 10:90-60:40, and then the mixture is stirred in a universal stirring machine or a planetary stirring machine with a first stage of low speed 0-5 rpm for 5-30 minutes, a second stage of high speed 15-60 rpm for 20-60 minutes, with all the stages controlled in the temperature 20-60° C., and with the viscosity of the silicone oil being 100 CS-500,000 CS.

3. The method for manufacturing anti-bacteria silicone rubber compound as claimed in claim 1, wherein the second step of rolling and pressing is carried out by three rollers 1-20 times, with the temperature of the rollers being 15-50° C.

4. The method for manufacturing anti-bacteria silicone rubber compound as claimed in claim 1, wherein said transparent two-component-liquid-type A/B basic material is a mixture of silicone oil and a reinforcing agent, and said dispersed anti-bacteria basic material is solely or evenly added with 0.05-5 phr in the transparent two-component-liquid-type A/B basic material and then stirred and dispersed in a planetary stirring machine for 1-5 times, and each stirring and dispersing operation includes a first stage of low speed 10-50 rpm, a second stage of high speed 20-100 rpm, a third stage of removing bubbles by means vacuuming with 1 Torr-100 Torr, a fourth stage of stirring with low speed 10-50 rpm and bubble removing by means of vacuuming with 1 Torr-100 Torr, and a last fifth stage of stirring with high speed 20-100 rpm and bubble removing by means of vacuuming with 1 Torr-100 Torr, with all the stages controlled in the temperature 15-70° C.

5. The method for manufacturing anti-bacteria silicone rubber compound as claimed in claim 1, wherein the anti-bacteria liquid silicone rubber compound liquid is filtered by a metal or nylon net with meshes 50-300.
